(19) United States
(12) Patent Application Publication
(10) Pub. No.: US 2026/0147494 A1
(43) Pub. Date: May 28, 2026

(54) SELF-TUNING FOR PERFORMANCE AND POWER IN A HIGH-BANDWIDTH MEMORY DEVICE

(71) Applicant: Micron Technology, Inc., Boise, ID (US)

(72) Inventors: Bokuba Nwengela, El Dorado Hills, CA (US); Raymond Chang, Sacramento, CA (US); Raghukiran Sreeramaneni, Frisco, TX (US); Nevil N. Gajera, Meridian, ID (US); Yasir Husain, Folsom, CA (US)

(21) Appl. No.: 19/352,966

(22) Filed: Oct. 8, 2025

Related U.S. Application Data
(60) Provisional application No. 63/724,766, filed on Nov. 25, 2024.

(51) Int. Cl. G06F 3/06

(52) U.S. Cl. CPC G06F 3/0634; G06F 3/061; G06F 3/0673

(57) ABSTRACT

Systems, devices, and methods for self-tuning high-bandwidth memory (HBM) devices for performance or power are disclosed herein. In some embodiments, an HBM device includes memory dies and TSVs. Each memory die can include a die identifier circuit configured to determine and store an identifier value unique to and indicating a stack position of the corresponding die, an I/O driver, and a scale logic circuit coupled to the die identifier circuit and the I/O driver. The scale logic circuit can be configured to receive the identifier value and a total stack height value associated with the HBM device, determine a scaling factor for the corresponding die based on the received identifier value and the received total stack height value, and generate, based on the determined scaling factor, an I/O control signal that configures the I/O driver to adjust a drive strength of the I/O driver by the determined scaling factor.

### CROSS-REFERENCE TO RELATED APPLICATION(S)

The present application claims priority to U.S. Provisional Patent Application No. 63/724,766, filed Nov. 25, 2024, the disclosure of which is incorporated herein by reference in its entirety.

### TECHNICAL FIELD

The present technology generally relates to vertically stacked semiconductor memory devices and, more specifically, to systems and methods for self-tuning for performance and power within high-bandwidth memory devices of a system-in-package.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet market demands, semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet market demands, such as by reducing the overall device footprint, can often introduce challenges in other aspects, such as maintaining circuit robustness and/or failure detectability.

### BRIEF DESCRIPTION OF THE DRAWINGS

FIG. 1 is a partially schematic cross-sectional diagram of a system-in-package device configured in accordance with some embodiments of the present technology.

FIG. 2 is a partially schematic cross-sectional diagram of a 2.5D HBM device, configured in accordance with some embodiments of the present technology.

FIG. 3 is a partially schematic cross-sectional diagram of a 3D HBM device, configured in accordance with some embodiments of the present technology.

FIG. 4 is a partially schematic cross-sectional diagram of 3D HBM device, configured in accordance with further embodiments of the present technology.

FIG. 5 is a flow diagram of a process for adjusting an input/output drive strength of a memory die in a stack of memory dies in accordance with some embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, vertically stacked memory devices have been introduced, often referred to as 2.5-dimensional (“2.5D”) memory devices when placed adjacent to a host device, and 3-dimensional (“3D”) memory devices when stacked above a host device. Some 2.5D and 3D memory devices are formed by stacking memory dies vertically and interconnecting the dies using through-silicon (or through-substrate) vias (TSVs). Benefits of the 2.5D and 3D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5D and 3D memory devices contribute to higher memory access speed, lower power consumption, and chip size reduction. Example 2.5D and 3D memory devices include Hybrid Memory Cube (HMC) and High-Bandwidth Memory (HBM) devices. For example, HBM devices are a type of memory that includes a vertical stack of dynamic random-access memory (DRAM) dies and, optionally, an interface die (which, e.g., provides the interface between the DRAM dies of the HBM device and a host device).

In a system-in-package (SiP) configuration, HBM devices may be integrated with a host device (e.g., a graphics processing unit (GPU), a computer processing unit (CPU), a tensor processing unit (TCU), and/or any other suitable processing unit) allowing communication therebetween. Because traffic between the HBM devices and host device resides within the SiP (e.g., using signals routed through the silicon interposer or TSVs), a higher bandwidth may be achieved between the HBM devices and host device than in conventional systems. In other words, the TSVs interconnecting DRAM dies within an HBM device, and the silicon interposer integrating HBM devices and a host device or the TSVs that extend between a host device and HBM devices stacked thereon, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host device (e.g., GPU/CPU/TCU) and HBM devices during operation. For example, the high-bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system.

Market demands on SiP devices and/or the HBM devices therein can present certain challenges, however. One such challenge is that the number of memory dies within a single stack is increasing (e.g., to 8, 16, 32 or more dies), thereby increasing the risk of variation in operating conditions across the stack. Although memory dies may be manufactured with identical or substantially similar specifications, when stacked together to form an HBM device, different dies can exhibit different operating conditions due to the different positions of the dies within the stack.

Furthermore, the memory dies of HBM devices can include input/output (I/O) drivers or circuits that communicatively couple the corresponding memory dies to signal TSVs that extend through the HBM device. However, I/O circuits of conventional HBM devices may be associated with various shortcomings. For example, the I/O circuits of all memory dies on a wafer may be configured (e.g., trimmed, set) at the wafer level (e.g., based on characteristics of the wafer as a whole). Because conventional memory dies lack the ability to identify their own position within the stack, it can be difficult to further configure (e.g., adjust the drive strength of) the I/O circuits based on the particular die's position within the stack.

For example, a bottom-most die may exhibit higher performance operating conditions (e.g., faster data transfer speeds, less signal delays) than the other dies in the same stack because the bottom-most die has the shortest electrical connection path (e.g., the shortest signal TSVs) to another die (e.g., an interface die, a host device, etc.), and thus the least resistance and capacitance that signals driven by I/O circuits encounter. Conversely, the top-most die may exhibit lower performance operating conditions (e.g., slower data transfer speeds, more signal delays) than the other dies in the same stack because the top-most die has the longest electrical connection path (e.g., the longest signal TSVs) to the another die (e.g., an interface die, a host device, etc.), and thus the greatest signal impedance (e.g., resistance and capacitance).

In another example, a top-most die may exhibit lower signal transmission speeds than the other dies in the same stack, notwithstanding having the same drive strength, because the top-most die has the longest electrical connection path (e.g., the longest signal TSVs) to another die (e.g., an interface die, a host device, etc.) and thus associated with higher signal impedance. Conversely, the bottom-most die may exhibit higher signal transmission speeds than the other dies in the same stack, notwithstanding having the same drive strength, because the bottom-most die has the shortest electrical connection path (e.g., the shortest signal TSVs) to the another die (e.g., an interface die, a host device, etc.), and thus associated with lower signal impedance. Therefore, the top-most die may be setting the overall speed of the HBM device, and the remaining dies may be overdriving their corresponding TSVs—and hence using more power—without achieving measurable benefits. Furthermore, variation in performance, power consumption, and/or other operating conditions between different memory dies in the same stack can lead to inconsistent performance of end user systems that include HBM devices.

The systems and methods described herein help address variation in operating conditions across the stack within HBM devices, and/or within the SiP devices more generally, by selectively adjusting the drive strength of the I/O driver of each die by a scaling factor determined based on the stack position of that particular die and the total stack height of the HBM device. As described herein, the I/O drivers, used to communicatively couple each die to the TSVs of the HBM device, may be adjusted differently for each of the memory dies. By accounting for the total stack height of the HBM device and each memory die's position within the stack, each memory die's I/O signaling over the TSVs (used, for example, to communicate between the memory die and the interface die or a host device) can be made more uniform throughout the HBM device (e.g., more similar, with respect to power and/or performance of the I/O signaling of the other memory dies). For example, the HBM devices described herein include a plurality of memory dies, each memory die including a scale logic circuit. As described further herein, the scale logic circuit can (a) receive (i) an identifier value unique to and indicating a stack position of the corresponding die and (ii) a total stack height value, (b) determine a scaling factor for the corresponding die based on the received identifier value and the received total stack height value, and (c) generate, based on the determined scaling factor, an I/O control signal, wherein the I/O control signal configures the I/O driver to adjust a drive strength of the I/O driver by the determined scaling factor. Further, as described herein, each of the plurality of memory dies can generate different I/O control signals in order to adjust the I/O drivers therein differently (e.g., increasing the I/O driver drive strength by different amounts for different memory dies).

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

Although primarily discussed herein in the context of HBM devices with scale logic circuits, one of skill in the art will understand that the scope of the invention is not so limited. For example, various components of the SiP devices described herein can also be implemented with scale logic circuits. Further, although the memory dies illustrated and discussed herein include embodiments of die identifier circuits, one of skill in the art will understand that the scale logic circuits can use inputs from other embodiments of die identifier circuits or other devices, such as a host device or an external device. Accordingly, the scope of the invention is not confined to any subset of embodiments and is confined only by the limitations set out in the appended claims.

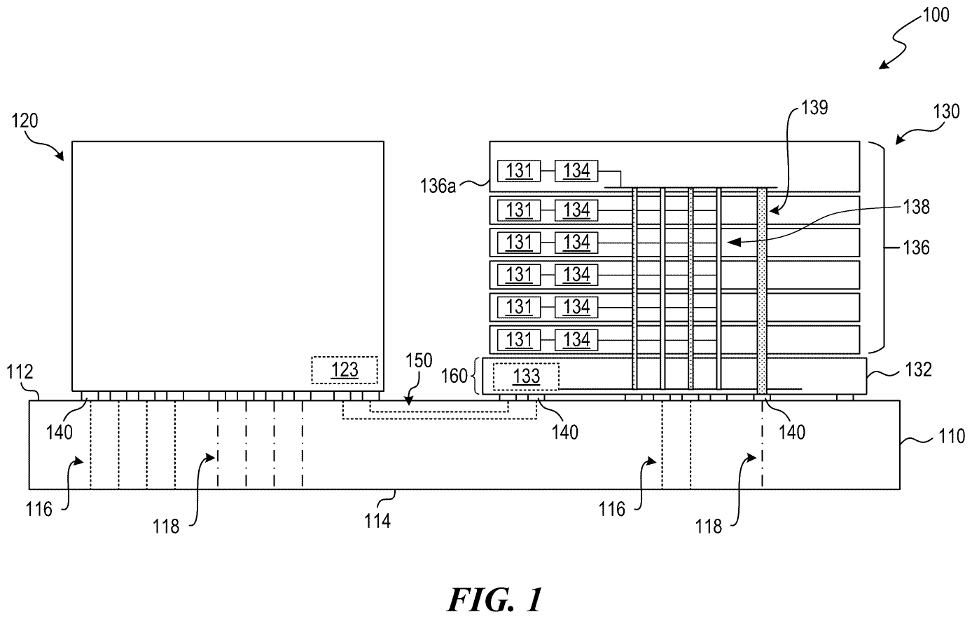

FIG. 1 is a partially schematic cross-sectional diagram of a SiP device 100 configured in accordance with some embodiments of the present technology. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, bumps, micro bumps, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110 (sometimes referred to as a SiP bus). The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between the host device 120 and/or the HBM device 130 and an external component (e.g., a PCB the base substrate 110 is integrated with, an external controller, and/or the like). The external power TSVs 118 provide electrical power to the host device 120 and/or the HBM device 130 from an external power source.

The host device 120 can include a variety of components, such as a processing unit (e.g., CPU/GPU/TCU), one or more registers, one or more cache memories, and/or a variety of other components (not shown). In the illustrated environment, the host device 120 additionally includes a host input/output (I/O) circuit 123 that can direct signals to and/or from the HBM device 130 through the communication channels 150. Additionally, or alternatively, the host I/O circuit 123 can direct signals to and/or from an external component (e.g., a controller coupled to one or more of the external signal TSVs 116 and/or the like).

The HBM device 130 can include an interface die 132 and a stack of one or more memory dies 136 (six illustrated in FIG. 1) carried by the interface die 132. Each of the memory dies 136 can include an I/O driver 134 and a scale logic circuit 131 operably coupled to the I/O driver 134. The HBM device 130 also includes one or more signal TSVs 138 (four illustrated in FIG. 1) and one or more power TSVs 139 (one illustrated in FIG. 1) each extending from the interface die 132 to an uppermost memory die 136a. Each of the I/O drivers 134 can be communicatively coupled to and can drive the one or more signal TSVs 138. The power TSV(s) 139 provide power (e.g., received from one or more of the external power TSVs 118) to the interface die 132 and each of the memory dies 136. The signal TSVs 138 communicably couple each of the memory dies 136 to an I/O circuit 133 in the interface die 132 (in addition to various other circuits in the interface die 132). In turn, the I/O circuit 133 can direct signals to and/or from the host device 120 and/or an external component (e.g., an external storage device coupled to one or more of the external signal TSVs 116 and/or the like). As illustrated in FIG. 1, the I/O circuit 133 may be located at and/or near an edge 160 of the interface die 132 that is close to the host device 120 (i.e., the shoreline edge).

As discussed further herein, in embodiments of the present technology, the scale logic circuit 131 can receive an identifier value unique to the corresponding die 136 and a total stack height value, determine a scaling factor based on the received identifier value and the received total stack height value, and generate the I/O control signal. The I/O control signal can configure the corresponding I/O driver 134 to adjust the drive strength thereof by the determined scaling factor to drive the one or more signal TSVs 138 by the adjusted drive strength. Adjusting the drive strength of the I/O driver 134 can affect operating conditions of each of the memory dies 136, such as performance and power consumption. The determined scaling factor and the generated I/O control signal can be unique to the particular die 136. Therefore, the drive strength of the I/O driver 134 of each of the memory dies 136 can be selectively and individually tuned or adjusted (e.g., by different amounts) to achieve uniformity in one or more operating conditions across the HBM device 130.

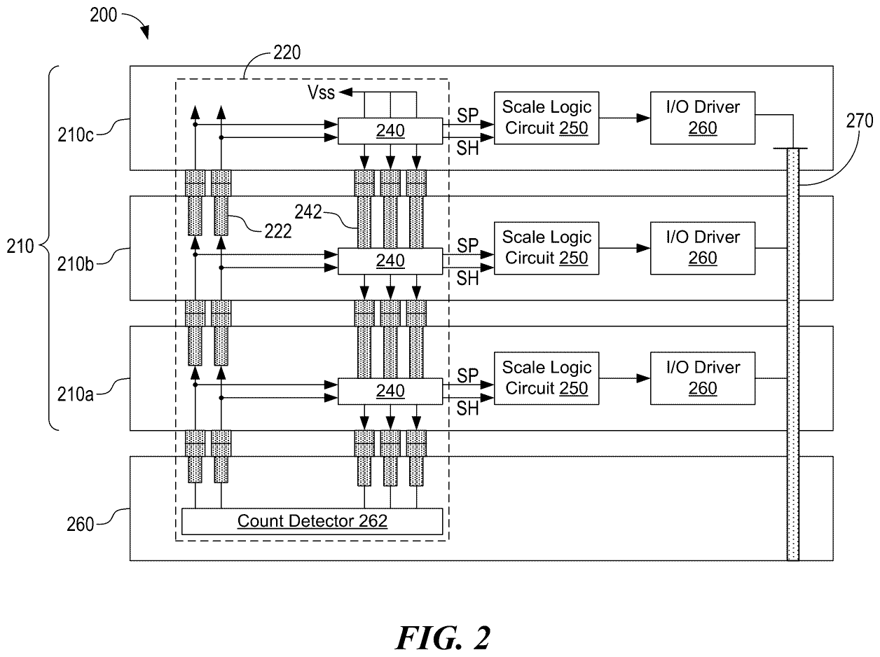

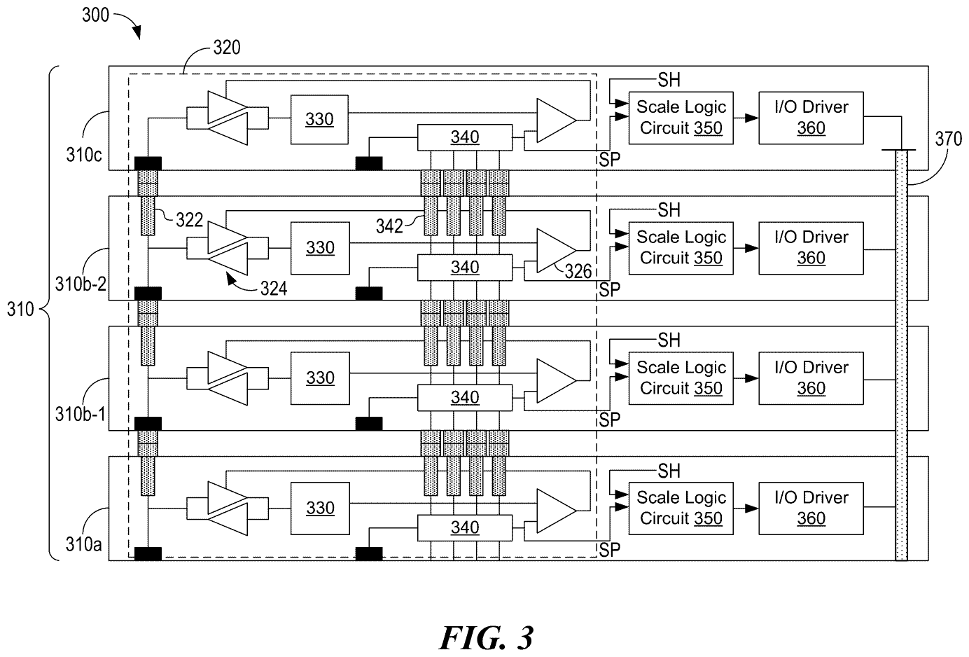

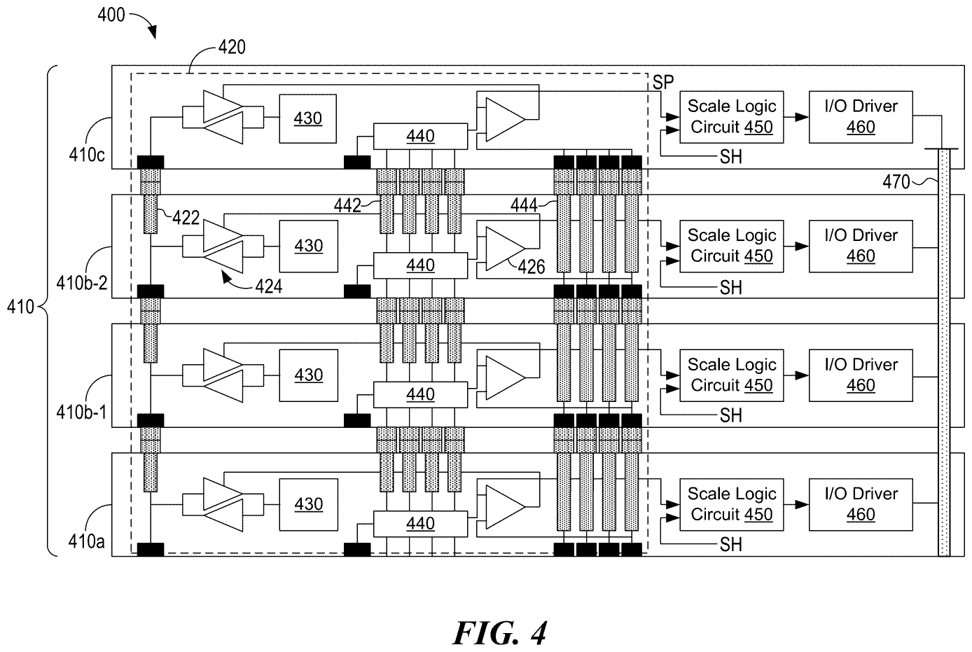

Notably, FIG. 1 illustrates a 2.5D SiP device in which the host device 120 and the HBM device 130 are carried by the base substrate 110. As discussed further herein, FIG. 2 illustrates embodiments of the present technology configured for use in a 2.5D SiP. It will be appreciated, however, that embodiments of the present technology can also be configured for use in a 3D SiP in which the HBM device 130 is carried by the host device 120, and may omit the interface die 132. As discussed further herein, FIGS. 3 and 4 illustrate embodiments of the present technology configured for use in a 3D SiP.

FIG. 2 is a partially schematic cross-sectional diagram of a 2.5D HBM device 200 (“the HBM device 200”), configured in accordance with some embodiments of the present technology. The HBM device 200 can include an interface die 260, a stack of one or more memory dies 210 (three illustrated in FIG. 2) carried by the interface die 260, and one or more signal TSVs 270 (one illustrated in FIG. 2). It will be appreciated that the HBM device 200 can be an example of the HBM device 130, the interface die 260 can be an example of the interface die 132, the memory dies 210 can be examples of the memory dies 136, and the one or more signal TSVs 270 can be examples of the signal TSVs 138 of FIG. 1.

The HBM device 200 can include an identification block 220 which, as described below, facilitates determining a stack height of the HBM device 200 (that is, how many memory dies 210 form the HBM device 200) and determining the position of each memory die 210 within the stack (that is, it is the bottom-most die, the top-most die, etc.). As illustrated in FIG. 2, the identification block 220 can include a die identifier circuit 240 (e.g., a counter) of each of the memory dies 210, a count detector circuit 262 of the interface die 260, one or more external communication vias 222, and one or more self-identifier vias 242. The external communication vias 222 can provide or form an external communication path (e.g., a bus) between the memory dies 210 and the count detector circuit 262. The self-identifier vias 242 can extend between and electrically couple the die identifier circuits 240 and the count detector circuit 262. The die identifier circuit 240 of each memory die 210 can receive signals from the external communication path formed by the external communication vias 222. Moreover, the external communication vias 222 and self-identifier vias 242 can extend through a bottom-most die 210a and one or more intermediate dies 210b (one illustrated in FIG. 2), and the die identifier circuit 240 of a top-most die 210c can be coupled to a reference voltage Vss.

In operation, the identification block 220 can determine identifier values, each unique to a particular memory die 210 and indicating a stack position (SP) of the particular memory die 210, and a total stack height value (SH) of the HBM device 200. The stack position SP can be a binary string, a plain number, or other data form that indicates the stack level, or position, of a particular memory die 210 in the stack. For example, in the illustrated embodiment, the die identifier circuit 240 of the die 210a can encode that the die 210a is the first or bottom-most die (i.e., closest to the interface die 260), the die identifier circuit 240 of the die 210b can encode that the die 210b is the second die, and the die identifier circuit 240 of the die 210c can encode that the die 210c is the third or top-most die (i.e., farthest from the interface die 260). Continuing with the illustrated example, the count detector circuit 262 can encode that there is a total of three memory dies in the device.

In some embodiments, the stack position SP and/or the total stack height value SH are stored in the die identifier circuit 240 (or elsewhere) and accessed during, e.g., an initialization sequence of the HBM device 200. In some embodiments, the identification block 220 determines the stack position SP of each memory die 210 and/or the total stack height value SH of the HBM device 200 during, e.g., an initialization sequence of the HBM device 200. Further details on example systems and methods for determining the stack position and the total stack height value SH are provided in U.S. patent application Ser. No. 19/287,461, titled “APPARATUS INCLUDING STACK TESTING MECHANISM AND ASSOCIATED METHODS,” and filed Jul. 31, 2025, which is incorporated by reference herein in its entirety.

Each of the memory dies 210 can further include a scale logic circuit 250 and an I/O driver 260. The scale logic circuit 250 can include combinatorial logic, look-up tables, transistors, resistors, capacitors, diodes, and/or other circuit components in a defined configuration to perform various logic operations. The scale logic circuit 250 can be coupled to receive data signals from the corresponding die identifier circuit 240 and output control signals to the corresponding I/O driver 260. The I/O driver 260 can form part of a transceiver (or separate transmitter and receiver) of the memory die 210, and can have a drive strength for driving signals between the memory dies 210. For example, the I/O driver 260 can be coupled to and drive the one or more signal TSVs 270.

The scale logic circuit 250 of each memory die 210 can receive the stack position SP (e.g., of the identifier value unique to the corresponding memory die 210) and the total stack height value SH from the identification block 220 (e.g., from the corresponding die identifier circuit 240). The scale logic circuit 250 can then determine a scaling factor for the corresponding memory die 210 based on the received stack position SP and the total stack height value SH. In some embodiments, the scale logic circuit 250 can determine the scaling factor by accessing a specific stored value, referencing a lookup table (e.g., programmed during assembly and/or validation), using combinatorial logic, and/or the like. Subsequently, the scale logic circuit 250 can generate, based on the determined scaling factor, an I/O control signal. The generated I/O control signal can be sent to and configure the corresponding I/O driver 260 to adjust a drive strength of the I/O driver 260 by the determined scaling factor. Therefore, the scale logic circuits 250 can selectively control the drive strengths of the transceivers included in the HBM device 200 on a die-by-die basis based on how many memory dies 210 are included in the stack and where each memory die 210 is positioned within the stack.

In some embodiments, the scale logic circuit 250 can be configured to determine the scaling factor further based on a mode signal or configuration signal. As described herein, the mode signal or configuration signal can configure the scale logic circuit 250 of each memory die 210 to adjust the drive strength of the I/O driver 260 in a manner that may best achieve a particular goal (for example, adjusting drive strengths in the HBM device 200 to optimize for power or performance). Although the memory dies 210 may be manufactured with identical or substantially similar specifications, when stacked together to form the HBM device 200, different ones of the memory dies 210 can exhibit different operating conditions due to the different stack positions of the memory dies 210. Variation in operating conditions within the stack can lead to inconsistent performance of end user systems that include the HBM device 200. Thus, the mode or configuration signal (e.g., driven by a configuration register, a fuse, and/or the like) can configure the scale logic circuits 250 to achieve uniformity in one or more operating conditions across the memory dies 210.

As described above, in conventional HBM devices, the I/O drivers of memory dies are typically configured or trimmed at the wafer level (e.g., based on a characterization of the entire wafer), without the benefit of knowing where individual memories dies will be placed in an HBM stack or the size of said HBM stack. As a result, memory dies closer to the interface die may utilize a drive strength that is higher than necessary (e.g., it operates faster than needed) and/or memory dies farther from the interface die may utilize an insufficient drive strength (e.g., it operates too slow). As described below, the scale logic circuit 250 can be configured to adjust the drive strengths of individual memory die 210 based on the received stack position SP and the total stack height value SH. In some embodiments, the scale logic circuit 250 can receive a mode signal that further adjusts how drive strengths are adjusted. For example, as described below, the mode signal can configure the memory dies 210 to optimize for performance or to optimize for power.

In some embodiments, a configuration register, a fuse, and/or the like can drive a mode signal to the scale logic circuit 250 to optimize for performance. In response, the scale logic circuit 250 can generate an I/O control signal to configure the corresponding I/O driver 260 to adjust the drive strength to match a baseline value, such as an expected drive strength of the bottom-most die 210a. In some embodiments, the scale logic circuit 250 can use a scaling factor that is predetermined based on, e.g., the expected drive strength of the bottom-most die 210a provided by the manufacturer or supplier, the ratio between the drive strengths of the corresponding die and the bottom-most die 210a according to prior operation tests, prior silicon characterizations, calibrations for specific operating conditions, and/or the like. In some embodiments, the predetermined scaling factors, expressed as a function of an HBM stack height and the position of a memory die within the stack, are stored on the respective die identifier circuit 240 and/or the scale logic circuit 250. Because the bottom-most die 210a is expected to have the highest performance conditions for the reasons discussed above, in some cases, the determined scaling factor for the remaining ones of the memory dies 210 can be greater than 1. For example, the bottom-most die 210a can have a scaling factor of 1 (e.g., no adjustment to drive strength), the intermediate die 210 b can have a scaling factor of 1.2, and the top-most die 210 c can have a scaling factor of 1.5. It will be appreciated that the aforementioned scaling factors (e.g., 1.2, 1.5) are merely illustrative examples. The scaling factors can be configured (e.g., via prior operation tests, prior silicon characterizations, and/or the like, as described above) such that (i) the drive strengths of the I/O drivers 260 of the remaining ones of the memory dies 210 (e.g., excluding the bottom-most die 210a) are increased to compensate for the higher signal impedance associated with the particular memory die 210 and, consequently, (ii) the effective signal speeds of the memory dies 210 are uniform (e.g., signals communicated between the memory dies 210 and the interface die 260 reach their destinations at around the same time). Thus, the generated I/O control signals can configure the I/O drivers 260 of the remaining ones of the memory dies 210 to increase their drive strengths, ideally matching the performance conditions of the I/O driver 260 of the bottom-most die 210a (e.g., the baseline drive strength) and achieving uniform performance conditions across the stack.

In some embodiments, a configuration register, a fuse, and/or the like can drive a mode signal to the scale logic circuit 250 to optimize for power consumption. In response, the scale logic circuit 250 can generate an I/O control signal to configure the corresponding I/O driver 260 to adjust the drive strength to match a baseline value, such as an expected drive strength of the top-most die 210c. In some embodiments, the scale logic circuit 250 can use a scaling factor that is predetermined based on, e.g., the expected drive strength of the top-most die 210c provided by the manufacturer or supplier, the ratio between the drive strengths of the corresponding die and the top-most die 210c according to prior operation tests, prior silicon characterizations, calibrations for specific operating conditions, and/or the like. Because the top-most die 210c is expected to have the slowest signal speed for the reasons discussed above, in some cases, the determined scaling factor for the remaining ones of the memory dies 210 can be less than 1. For example, the top-most die 210c can have a scaling factor of 1 (e.g., no adjustment to drive strength), the intermediate die 210 b can have a scaling factor of 0.8, and the bottom-most die 210 a can have a scaling factor of 0.7. It will be appreciated that the aforementioned scaling factors (e.g., 0.8, 0.7) are merely illustrative examples. The scaling factors can be configured (e.g., via prior operation tests, prior silicon characterizations, and/or the like, as described above) such that (i) the drive strengths of the I/O drivers 260 of the remaining ones of the memory dies 210 (e.g., excluding the top-most die 210c) are decreased to account for the lower signal impedance associated with the particular die 210 and, consequently, (ii) the remaining ones of the memory dies 210 consume less power than needed and (iii) the effective signals speeds of the remaining ones of the memory dies 210 are uniform (e.g., signals communicated between the memory dies 210 and the interface die 260 reach their destinations at around the same time). Thus, the generated I/O control signals can configure the I/O drivers 260 of the remaining ones of the memory dies 210 to decrease their drive strengths, ideally matching the effective signal speeds of the I/O driver 260 of the top-most die 210c (e.g., the baseline drive strength) and achieving reduced power consumption of the remaining ones of the memory dies 210.

In some embodiments, the mode signal that configures the HBM device to adjust I/O drive strengths for power or performance is determined by one or more configuration registers (included in the HBM device, included in a host device coupled to the HBM device, etc.) and/or configuration fuse (in the HBM device). That is, the HBM device can be configured to attempt to optimize the drive strengths for power or performance based on configuration register programmed from the host device. Accordingly, the register (or other device) can generate and transmit the mode signal indicating the performance mode or the power consumption mode to the scale logic circuits 250 of the memory dies 210 of the HBM device 200.

FIG. 3 is a partially schematic cross-sectional diagram of a 3D HBM device 300 (“the HBM device 300”), configured in accordance with some embodiments of the present technology. The HBM device 300 can include a stack of one or more memory dies 310 (four illustrated in FIG. 3) and one or more signal TSVs 370. While not shown in FIG. 3, the HBM device 300 can additionally include an interface die carrying the memory dies 310. It will be appreciated that the HBM device 300 can be an example of the HBM device 130, the memory dies 310 can be examples of the memory dies 136, and the one or more signal TSVs 370 can be examples of the signal TSVs 138 of FIG. 1. Also, as discussed above, the 3D HBM device 300 can be carried by a host device (e.g., the host device 120).

The HBM device 300 can include an identification block 320 including a buffer circuit 324, an internal circuit 330, a die identifier circuit 340 (e.g., a counter), and a comparator 326, among other components, of each of the memory dies 310. The identification block 320 can additionally include one or more external communication vias 322, and one or more self-identifier vias 342. The external communication vias 322 can provide or form an external communication path (e.g., a bus) between the memory dies 310 and to a device external to the HBM device 300. The self-identifier vias 342 can extend between and electrically couple the die identifier circuits 340 to one another. Moreover, the external communication vias 322 and the self-identifier vias 342 can extend through a bottom-most die 310a and one or more intermediate dies 310b (two illustrated in FIG. 3). The memory dies 310 can further include a top-most die 310c.

In operation, the identification block 320 can function in a similar manner as the identification block 220 of FIG. 2. The identification block 320 can determine identifier values, each unique to a particular memory die 310 and indicating a stack position (SP) of the particular memory die 310, and a total stack height value (SH) of the HBM device 300. For example, in the illustrated embodiment, the die identifier circuit 340 of the die 310a can encode that the die 310a is the first or bottom-most die, the die identifier circuit 340 of the die 310b-1 can encode that the die 310b-1 is the second die, the die identifier circuit 340 of the die 310b-2 can encode that the die 310b-2 is the third die, and the die identifier circuit 340 of the die 310c can encode that the die 310c is the fourth or top-most die.

Each of the memory dies 310 can further include a scale logic circuit 350 and an I/O driver 360. The scale logic circuit 350 can include combinatorial logic, look-up tables, transistors, resistors, capacitors, diodes, and/or other circuit components in a defined configuration to perform various logic operations. The scale logic circuit 350 can be coupled to receive data signals from the corresponding die identifier circuit 340 and/or other devices, and output control signals to the corresponding I/O driver 360. The I/O driver 360 can form part of a transceiver (or separate transmitter and receiver) of the memory die 310, and can have a drive strength for driving signals between the memory dies 310. For example, the I/O driver 360 can be coupled to and drive the one or more signal TSVs 370.

In operation, the scale logic circuits 350 and the I/O drivers 360 can function in a similar manner as the scale logic circuits 250 and the I/O drivers 260 of FIG. 2, respectively. The scale logic circuits 350 can receive the stack position SP of the corresponding memory die 310 and the total stack height value SH from the identification block 320. In some embodiments, the scale logic circuits 350 can receive the total stack height value SH from a different device (e.g., a device external to the HBM device 300). Each scale logic circuit 350 can the determine a scaling factor for the corresponding memory die 310 based on the received stack position SP and the total stack height value SH. Subsequently, the scale logic circuit 350 can generate, based on the determined scaling factor, an I/O control signal to be sent to and configure the corresponding I/O driver 360 to adjust a drive strength of the I/O driver 360 by the determined scaling factor.

As discussed above with reference to FIG. 2, the scale logic circuit 350 can be configured to determine the scaling factor further based on a mode signal or configuration signal, which can configure the scale logic circuit 350 of each memory die 310 to adjust the drive strength of the I/O driver 360 in a manner that may best achieve a particular goal (for example, adjusting drive strengths in the HBM device 300 to optimize for power or performance). Although the memory dies 310 may be manufactured with identical or substantially similar specifications, when stacked together to form the HBM device 300, different ones of the memory dies 310 can exhibit different operating conditions due to the different stack positions of the memory dies 310. Variation in operating conditions within the stack can lead to inconsistent performance of end user systems that include the HBM device 300. Thus, the mode or configuration signal (e.g., driven by a configuration register, a fuse, and/or the like) can configure the scale logic circuits 350 to achieve uniformity in one or more operating conditions across the memory dies 310.

FIG. 4 is a partially schematic cross-sectional diagram of 3D HBM device 400 (“the HBM device 400”), configured in accordance with further embodiments of the present technology. The HBM device 400 can be generally similar to the HBM device 300 of FIG. 3. For example, the HBM device 400 can include a stack of one or more memory dies 410 (four illustrated in FIG. 3) including a bottom-most die 410a, one or more intermediate dies 410b, and a top-most die 410c, and one or more signal TSVs 470. The HBM device 400 can include an identification block 420 including a buffer circuit 424, an internal circuit 430, a die identifier circuit 440 (e.g., a counter), and a comparator 426, among other components, of each of the memory dies 410, one or more external communication vias 422, and one or more self-identifier vias 442. Unlike the HBM device 300 of FIG. 3, however, the HBM device 400 can further include a die selector bus having die selector vias 444. Like the external communication vias 422, the die selector vias 444 can provide communicative paths that extend across or through the body of the dies 410 and can allow the die selection signals (e.g., received from a device external to the HBM device 400) to be broadcasted over the die selector bus.

In operation, the identification block 420 can function in a similar manner as the identification block 220 of FIG. 2. The identification block 420 can determine identifier values, each unique to a particular memory die 410 and indicating a stack position (SP) of the particular memory die 410, and a total stack height value (SH) of the HBM device 400. For example, in the illustrated embodiment, the die identifier circuit 440 of the die 410a can encode that the die 410a is the first or bottom-most die, the die identifier circuit 440 of the die 410b-1 can encode that the die 410b-1 is the second die, the die identifier circuit 440 of the die 410b-2 can encode that the die 410b-2 is the third die, and the die identifier circuit 440 of the die 410c can encode that the die 410c is the fourth or top-most die.

In operation, the scale logic circuits 450 and the I/O drivers 460 can function in a similar manner as the scale logic circuits 250 and the I/O drivers 260 of FIG. 2, respectively. The scale logic circuits 450 can receive the stack position SP of the corresponding memory die 410 and the total stack height value SH from the identification block 420. In some embodiments, the scale logic circuits 450 can receive the total stack height value SH from a different device (e.g., a device external to the HBM device 400). Each scale logic circuit 450 can the determine a scaling factor for the corresponding memory die 410 based on the received stack position SP and the total stack height value SH. Subsequently, the scale logic circuit 450 can generate, based on the determined scaling factor, an I/O control signal to be sent to and configure the corresponding I/O driver 460 to adjust a drive strength of the I/O driver 460 by the determined scaling factor.

As discussed above with reference to FIG. 2, the scale logic circuit 450 can be configured to determine the scaling factor further based on a mode signal or configuration signal, which can configure the scale logic circuit 450 of each memory die 410 to adjust the drive strength of the I/O driver 460 in a manner that may best achieve a particular goal (for example, adjusting drive strengths in the HBM device 400 to optimize for power or performance). Although the memory dies 410 may be manufactured with identical or substantially similar specifications, when stacked together to form the HBM device 400, different ones of the memory dies 410 can exhibit different operating conditions due to the different stack positions of the memory dies 410. Variation in operating conditions within the stack can lead to inconsistent performance of end user systems that include the HBM device 400. Thus, the mode or configuration signal (e.g., driven by a configuration register, a fuse, and/or the like) can configure the scale logic circuits 450 to achieve uniformity in one or more operating conditions across the memory dies 410.

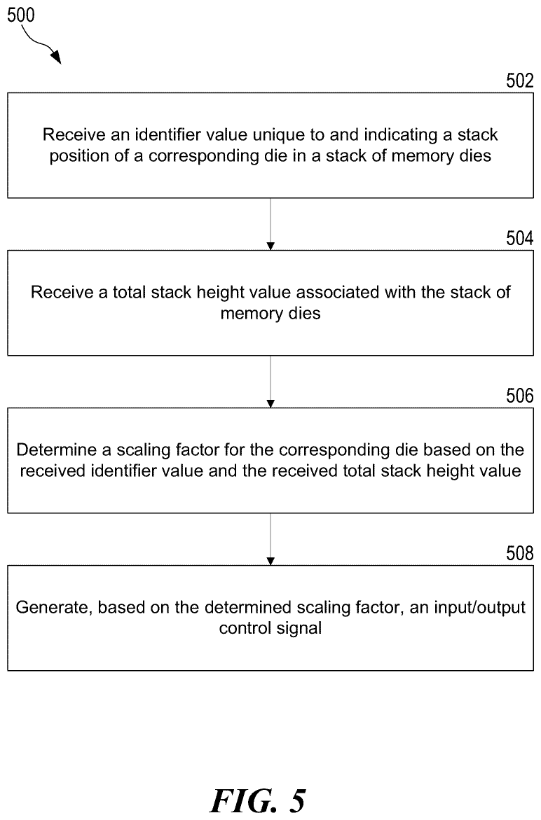

FIG. 5 is a flowchart illustrating a method 500 for adjusting an I/O drive strength of a memory die in a stack of memory dies in accordance with some embodiments of the present technology. While the steps of the method 500 are described below in a particular order, one or more of the steps can be performed in a different order or omitted, and the method 500 can include additional and/or alternative steps. Additionally, although the method 500 may be described below with reference to the embodiments of the present technology described herein, the method 500 can be performed with other embodiments of the present technology.

The method 500 begins at block 502 by receiving an identifier value unique to and indicating a stack position of a corresponding die in a stack of memory dies. In some embodiments, the identifier value is received from an identification block (e.g., including a die identifier circuit) that can determine the stack position of each die (e.g., during the initialization sequence of the HBM device).

At block 504, the method 500 continues by receiving a total stack height value associated with the stack of memory dies. In some embodiments, the total stack height value is received from the identification block included in the HBM device.

At block 506, the method 500 continues by determining a scaling factor for the corresponding die based on the received identifier value and the received total stack height value. In some embodiments, the scaling factor is determined by accessing a specific stored (e.g., predetermined) value, referencing a lookup table, using combinatorial logic, and/or the like, that expresses a scaling factor as a function of total stack height and a die's position within the stack. In some embodiments, the method 500 further includes receiving a mode signal indicating a uniform operating mode of the stack of memory dies, and the scaling factor can be determined further based on achieving uniformity of an operating condition across the stack of memory dies. For example, the mode signal can indicate a performance mode or a power consumption/saving mode, and the scaling factor can be determined such that the drive strength of the I/O driver of the corresponding die is adjusted to match a baseline drive strength.

For example, in the event that the mode signal indicates a performance mode, the drive strengths of the dies in the stack excluding the bottom-most die can be increased so that the effective signal speeds of the memory dies are uniform (e.g., signals communicated between the memory dies and the interface die reach their destinations at around the same time). In some embodiments, the drive strengths of dies higher up in the stack are increased by a greater degree than the drive strengths of dies lower down in the stack. In another example, in the event that the mode signal indicates a power consumption/saving mode, the drive strengths of the dies in the stack excluding the top-most die can be decreased so that the effective signal speeds of the memory dies are uniform (e.g., signals communicated between the memory dies and the interface die reach their destinations at around the same time). In some embodiments, the drive strengths of dies lower down in the stack are decreased by a greater degree than the drive strengths of dies higher up in the stack.

At block 508, the method 500 continues by generating, based on the determined scaling factor, an I/O control signal. The I/O control signal can configure an I/O driver of the corresponding die to adjust a drive strength of the I/O driver by the determined scaling factor. As discussed further herein, the scaling factor can be determined such that the drive strength of the corresponding die is adjusted (e.g., increased, decreased) to achieve uniformity of an operating condition (e.g., performance, power consumption) across the stack of dies.

It will be appreciated that in some embodiments, the method 500 can be performed by a scale logic circuit (e.g., the scale logic circuits 250, 350, 450). In some embodiments, the method 500 is performed during an initialization sequence of an HBM device. It will further be appreciated that the method 500 can repeat for each of the memory dies in the HBM device. That is, for each memory die, the method 500 can determine a drive strength for that memory die based on its individual placement within the HBM stack.

Referring to FIGS. 2-5 together, the scale logic circuits described herein can generate I/O control signals that configure the corresponding I/O drivers to adjust their drive strengths. In some embodiments, as discussed above with reference to FIG. 2, the I/O control signal can be generated based on scaling factors determined to achieve uniformity of one or more operating conditions across the stack. For example, the scaling factors can be determined to selectively adjust the drive strengths of the I/O drivers of different dies to match the drive strength of the I/O driver 260 of a select one of the memory dies (e.g., the baseline drive strength) and achieve uniform performance or power consumption conditions across the stack. Uniformity of one or more operating conditions across the stack can help ensure performance consistency of end user systems that incorporate HBM devices, and can also result in power savings due to optimized drive strengths of the I/O drivers.

Also, it is appreciated that while the HBM devices are illustrated herein with particular embodiments of the identification blocks, in other embodiments, HBM devices can have different circuitry for determining the stack position SP of each die and the total stack height value SH of the stack. Additionally or alternatively, the HBM devices may omit internal circuitry for determining the stack position SP of each die and the total stack height value SH of the stack, and/or may instead receive one or both of these values from a device external to the HBM device (e.g., a host device, an external device, etc.).

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and/or “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A high-bandwidth memory (HBM) device, comprising:
a plurality of memory dies, each memory die including:
a die identifier circuit configured to determine and store an identifier value unique to and indicating a stack position of the corresponding die;
an input/output (I/O) driver; and
a scale logic circuit coupled to the die identifier circuit and the I/O driver, wherein the scale logic circuit is configured to:
receive the identifier value from the die identifier circuit and a total stack height value associated with the plurality of memory dies,
determine a scaling factor for the corresponding die based on the received identifier value and the received total stack height value, and
generate, based on the determined scaling factor, an I/O control signal, wherein the I/O control signal configures the I/O driver to adjust a drive strength of the I/O driver by the determined scaling factor; and
a plurality of through-silicon vias (TSVs) extending through the plurality of memory dies, wherein the I/O drivers are configured to drive the TSVs across the plurality of memory dies.

2. The HBM device of claim 1, wherein the scale logic circuit of each die is further configured to receive a mode signal indicating a performance mode of the HBM device, and wherein the scaling factor for the corresponding die is based on an expected drive strength of the I/O driver of a bottom-most memory die of the plurality of memory dies.

3. The HBM device of claim 2, wherein the determined scaling factors for the plurality of memory dies, excluding the bottom-most memory die, are each greater than 1.

4. The HBM device of claim 1, wherein the scale logic circuit of each memory die is configured to determine the scaling factor for the corresponding memory die such that the drive strengths of dies stacked higher up are increased by a greater degree than the drive strengths of dies stacked lower down.

5. The HBM device of claim 1, wherein the scale logic circuit of each die is further configured to receive a mode signal indicating a power consumption/saving mode of the HBM device, and wherein the scaling factor for the corresponding die is based on an expected drive strength of the I/O driver of a top-most memory die of the plurality of memory dies.

6. The HBM device of claim 5, wherein the determined scaling factors for the plurality of memory dies, excluding the top-most memory die, are each less than 1.

7. The HBM device of claim 1, wherein the scale logic circuit of each die is configured to adjust the drive strength of the I/O driver by the determined scaling factor to match a baseline drive strength.

8. The HBM device of claim 1, the HBM device further comprising an interface die carrying the plurality of memory dies, wherein the scale logic circuit of each memory die is configured to receive the total stack height value from the interface die.

9. The HBM device of claim 1, wherein the scale logic circuit of each memory die is configured to determine the scaling factor for the corresponding memory die such that the drive strengths of dies stacked lower down are decreased by a greater degree than the drive strengths of dies stacked higher up.

10. The HBM device of claim 1, wherein the plurality of TSVs includes:
one or more external communication vias providing an external communication path between the plurality of memory dies; and
one or more self-identifier vias extending between the die identifier circuits of the plurality of memory dies.

11. A method for adjusting an input/output (I/O) drive strength of a memory die in a stack of memory dies, the method comprising:
receiving an identifier value unique to and indicating a stack position of a corresponding die in a stack of memory dies;
receiving a total stack height value associated with the stack of memory dies;
determining a scaling factor for the corresponding die based on the received identifier value and the received total stack height value; and
generating, based on the determined scaling factor, an input/output (I/O) control signal, wherein the I/O control signal configures an I/O driver of the corresponding die to adjust a drive strength of the I/O driver by the determined scaling factor.

12. The method of claim 11, further comprising receiving a mode signal indicating a uniform operating mode of the stack of memory dies, wherein determining the scaling factor comprises determining the scaling factor further based on achieving uniformity of an operating condition across the stack of memory dies.

13. The method of claim 11, further comprising receiving a mode signal indicating a performance mode of the stack of memory dies, wherein determining the scaling factor comprises determining the scaling factor such that the drive strength of the I/O driver of the corresponding die is adjusted to match a baseline drive strength.

14. The method of claim 11, further comprising receiving a control signal indicating a power consumption/saving mode of the stack of memory dies, wherein determining the scaling factor comprises determining the scaling factor such that the drive strength of the I/O driver of the corresponding die is adjusted to match a baseline drive strength.

15. The method of claim 11, wherein determining the scaling factor comprises selecting a predetermined value as the scaling factor.

16. The method of claim 11, wherein determining the scaling factor comprises referencing a lookup table.

17. A memory die, comprising:
an input/output (I/O) driver; and
a scale logic circuit operably coupled to the I/O driver, wherein the scale logic is configured to:
receive an identifier value unique to and indicating a stack position of the memory die, wherein the memory die is included in a high-bandwidth memory (HBM) device,
receive a total stack height value associated with the stack of memory dies,
determine a scaling factor for the memory die based on the received identifier value and the received total stack height value, and
generate, based on the determined scaling factor, an I/O control signal, wherein the I/O control signal configures the I/O driver to adjust a drive strength of the I/O driver by the determined scaling factor.

18. The memory die of claim 17, wherein the scale logic circuit is further configured to receive a mode signal indicating a performance mode of the stack of memory dies, and wherein the scale logic circuit is configured to determine the scaling factor in response to the control signal.

19. The memory die of claim 17, wherein the scale logic circuit is further configured to receive a mode signal indicating a power consumption/saving mode of the stack of memory dies, and wherein the scale logic circuit is configured to determine the scaling factor in response to the control signal.

20. The memory die of claim 17, further comprising a die identifier circuit configured to determine and store the identifier value.
